(19) United States
(12) Patent Application Publication
(10) Pub. No.: US 2026/0136123 A1
(43) Pub. Date: May 14, 2026

(54) CHARGING STRUCTURE AND WIRELESS EARPHONE

(71) Applicant: Luxshare precision accessory (Suzhou) LTD., Suzhou City (CN)

(72) Inventors: Hao HUANG, Suzhou City (CN); Gang HUANG, Suzhou City (CN); Shengxun QIN, Suzhou City (CN)

(73) Assignee: Luxshare precision accessory (Suzhou) LTD., Suzhou City (CN)

(21) Appl. No.: 19/223,125

(22) Filed: May 30, 2025

(30) Foreign Application Priority Data
Nov. 11, 2024 (CN) 202411603910.9

(51) Int. Cl. H04R 1/10; H01R 4/02; H01R 11/05

(52) U.S. Cl. CPC H04R 1/1025; H01R 4/027; H01R 11/05; H04R 1/1016; H04R 2420/07; H04R 2420/09

(57) ABSTRACT

Provided are a charging structure and a wireless earphone. The charging structure includes an insulating body, two charging terminals, and two connectors. The top surface of the insulating body is provided with an accommodating groove. One end of a battery cell is inserted into the accommodating groove. The two charging terminals are disposed in the insulating body. Each charging terminal includes a contact portion and a welding portion. The welding portion is provided with a welding protrusion. Each connector includes a connecting section and a collar. The collar is provided with a welding hole. For each connector, the collar of the connector is sleeved on a corresponding welding protrusion through the welding hole of the connector and is welded and secured to the corresponding welding protrusion. The connecting sections of the two connectors are connected to the positive electrode and the negative electrode of the battery cell respectively.

### CROSS-REFERENCE TO RELATED APPLICATION(S)

This application claims priority to Chinese Patent Application No. 202411603910.9 filed Nov. 11, 2024, the disclosure of which is incorporated herein by reference in its entirety.

### TECHNICAL FIELD

This disclosure relates to the field of wireless earphone charging technology, especially a charging structure and a wireless earphone.

### BACKGROUND

An earphone is an audio conversion unit that receives electrical signals from a media player or receiver and converts the electrical signals into audible sound waves using speakers placed adjacent to the ears. For handiness and ease of use, wireless earphones have gradually become the mainstream choice.

A wireless earphone establishes a signal transmission path through a wireless communication protocol and usually needs to be used in conjunction with a charging compartment. In an existing wireless earphone, a charging dock structure is located at the bottom of the earphone. A terminal of the charging structure needs to be welded to a connecting wire to connect the positive and negative terminals of a battery cell. However, between the terminal and the connecting wire in an existing earphone, there is point-to-point contact between one end of the connecting wire and one end of the terminal or point-to-surface contact between one end of the connecting wire and one surface of the terminal. This results in poor welding stability and a low yield rate.

### SUMMARY

This disclosure provides a charging structure and a wireless earphone.

The charging structure includes an insulating body, two charging terminals, and two connectors. A top surface of the insulating body is provided with an accommodating groove. One end of a battery cell is inserted into the accommodating groove. The two charging terminals are disposed in the insulating body. Each charging terminal includes a contact portion and a welding portion. The contact portion is exposed outside the insulating body. The welding portion is provided with a welding protrusion. Each connector includes a connecting section and a collar. The collar is provided with a welding hole. For each connector, the collar of the connector is sleeved on a corresponding welding protrusion through the welding hole of the connector and is welded and secured to the corresponding welding protrusion. The connecting sections of the two connectors are connected to the positive electrode of the battery cell and the negative electrode of the battery cell respectively.

In one or more embodiments, the charging structure also includes a flux. The flux is sleeved on the welding protrusion and is secured to the collar.

In one or more embodiments, each connector also includes an insulating sheath. The insulating sheath covers the connecting section and the collar. The insulating sheath is provided with a limiting hole. The welding hole is located in the limiting hole. The flux is located in the limiting hole and is secured to the collar.

In one or more embodiments, in a direction in which the welding protrusion is inserted into the welding hole, part of a projection of the welding portion is located outside the welding hole.

In one or more embodiments, the contact portion is provided with multiple ridges. The ridges are securely engaged with the insulating body.

In one or more embodiments, the welding portion is provided with a securing hole, and the insulating body includes a securing protrusion. The securing protrusion passes through the securing hole to secure the welding portion.

In one or more embodiments, each charging terminal also includes a connecting portion. Two ends of the connecting portion are connected to the contact portion and the welding portion respectively. The connecting portion includes multiple connecting subsections connected in sequence. Two adjacent connecting subsections are disposed at an angle to each other.

In one or more embodiments, the contact portion is provided with an engaging groove, and the insulating body is provided with an engaging portion. The engaging portion is in an engaging fit with the engaging groove.

In one or more embodiments, a connection position between the connecting portion and the contact portion is located in the engaging groove.

The wireless earphone includes the preceding charging structure, a housing, a battery cell, and a speaker. The housing is provided with a listening hole and a connecting hole. The charging structure closes the connecting hole. The speaker and the battery cell are disposed in the housing. The speaker is electrically connected to the battery cell. The speaker is configured to play sound through the listening hole.

### BRIEF DESCRIPTION OF DRAWINGS

FIG. 1 is a view of a charging structure according to an embodiment.

FIG. 2 is an exploded view of a charging structure according to an embodiment.

FIG. 3 is a view of a charging terminal and a connector according to an embodiment.

FIG. 4 is a view of an insulating body according to an embodiment.

FIG. 5 is a section view of a charging terminal and a connector according to an embodiment.

FIG. 6 is a view of a charging terminal according to an embodiment.

FIG. 7 is a view of a wireless earphone according to an embodiment.

### DETAILED DESCRIPTION

Embodiments of this disclosure are described in detail hereinafter. Examples of the embodiments are illustrated in the drawings, where the same or similar reference numerals indicate the same or similar elements or elements having the same or similar functions. The embodiments described below with reference to the drawings are illustrative and intended to explain this disclosure and cannot be construed as limiting this disclosure.

In the description of this disclosure, it should be understood that the orientational or positional relationships indicated by terms “center”, “above”, “below”, “left”, “right”, “vertical”, “horizontal”, “inside”, “outside” and the like are based on the orientational or positional relationships illustrated in the drawings, which are for the mere purpose of facilitating and simplifying the description of this disclosure, and these relationships do not indicate or imply that the device or component referred to has a specific orientation and is constructed and operated in a specific orientation, and thus it is not to be construed as limiting this disclosure. Moreover, terms such as “first” and “second” are used only for the purpose of description and are not to be construed as indicating or implying relative importance. Terms “first position” and “second position” are two different positions.

Unless otherwise expressly specified and limited, terms “mounted”, “joined”, “connected”, and “secured” are to be understood in a broad sense. For example, the term “connected” may refer to “securely connected” or “detachably connected”, may refer to “mechanically connected” or “electrically connected”, or may refer to “connected directly”, “connected indirectly through an intermediary”, “connected inside two components”, or “interaction relations between two components”. For those of ordinary skill in the art, specific meanings of the preceding terms in this disclosure may be understood based on specific situations.

Unless otherwise expressly specified and limited, when a first feature is described as “on” or “under” a second feature, the first feature and the second feature may be in direct contact or be in contact via another feature between the two features. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

The technical solutions in this disclosure are further described below in conjunction with the drawings and embodiments.

An earphone is an audio conversion unit that receives electrical signals from a media player or receiver and converts the electrical signals into audible sound waves using speakers placed adjacent to the ears. For handiness and ease of use, wireless earphones have gradually become the mainstream choice. A wireless earphone establishes a signal transmission path through a wireless communication protocol. To ensure the power supply of a wireless earphone, a battery cell is disposed inside the wireless earphone; therefore, the wireless earphone is usually used in conjunction with a charging compartment.

This embodiment provides a wireless earphone. As shown in FIG. 7, the wireless earphone includes a charging structure, a housing 100, and a speaker 101. The housing 100 is provided with a listening hole 102 and a connecting hole 103. The charging structure closes the connecting hole 103. The speaker 101 and a battery cell 2 are disposed in the housing 100. The speaker 101 is electrically connected to the battery cell. The speaker 101 plays sound through the listening hole 102. To enable the wireless earphone to receive an electrical signal sent by a media player, a wireless module is also disposed in the housing. The battery cell supplies power to the wireless module and the speaker to ensure the normal operation of the wireless module and the speaker.

In this embodiment, the wireless earphone also includes a microphone. The microphone is disposed in the housing 100 and is electrically connected to the battery cell 2 so that the wireless earphone has a function of receiving sound.

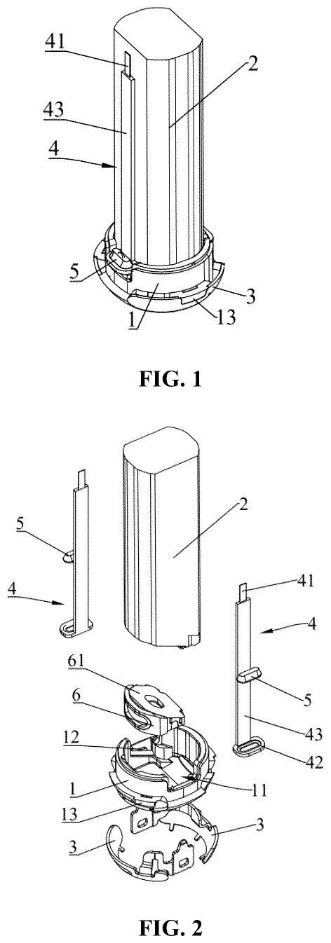

As shown in FIG. 1, in this embodiment, the connecting hole 103 of the housing 100 is located at the bottom, that is, the charging structure is disposed at the bottom of the wireless earphone, and the battery cell 2 is an elongated structure so that the positive electrode and the negative electrode of the battery cell 2 are adjacent to the microphone, the speaker, and the wireless module which are located at the top of the housing. Therefore, the terminal of the charging structure is welded to the connecting wire to connect the positive electrode and the negative electrode of the battery cell 2. However, it is difficult to secure the relative position between the terminal and the connecting wire, resulting in low welding precision, low welding efficiency, and a high production cost.

As shown in FIG. 1 to FIG. 3, to solve the preceding problem, this embodiment provides a charging structure. The charging structure includes an insulating body 1, two charging terminals 3, and two connectors 4. The two charging terminals 3 are disposed in the insulating body 1. Each charging terminal 3 includes a contact portion 31 and a welding portion 32. The contact portion 31 is located outside the insulating body 1. The welding portion 32 is provided with a welding protrusion 33. Each connector 4 includes a connecting section 41 and a collar 42. The collar 42 is provided with a welding hole 421. For each connector 4, the collar 42 of the connector 4 is sleeved on a corresponding welding protrusion 33 through the welding hole 421 of the connector 4 and is securely welded to the corresponding welding protrusion 33. Two connecting sections 41 of the two connectors 4 are connected to the positive electrode of the battery cell 2 and the negative electrode of the battery cell 2 respectively.

In the charging structure, each of the two charging terminals 3 has a welding protrusion 33, so before welding, the collar 42 of each connector 4 is sleeved on a corresponding welding protrusion 33, and the welding protrusion 33 supports and positions the connector 4 through the collar 42, thereby ensuring the stability of the relative position between the charging terminal 3 and the connector 4, eliminating the structure for securing the relative position between the charging terminal 3 and the connector 4, improving the welding precision, ensuring a high welding efficiency, and lowering the cost.

It is to be noted that if the position of the speaker of the wireless earphone is the top and the position of the microphone of the wireless earphone is the bottom, the welding protrusion 33 is disposed upward, and the collar 42 of the connector 4 is sleeved on the welding protrusion 33 in the direction from top to bottom so that the welding protrusion 33 supports the collar 42 before welded to the collar 42, ensuring the stability of the relative position between the welding protrusion 33 and the collar 42, facilitating welding and positioning, ensuring a suitable gap between the welding protrusion 33 and the collar 42, and ensuring the high welding stability.

The top surface of the insulating body 1 is provided with an accommodating groove 11. One end of the battery cell 2 is inserted into the accommodating groove 11. The accommodating groove 11 positions the battery cell 2, ensuring the stability of the battery cell 2 in the housing and reducing the possibility of damaging the battery cell 2 when the wireless earphone drops.

As shown in FIG. 4, a sidewall 14 of the insulating body 1 surrounding the accommodating groove 11 includes a bottom ring 141 and side walls 142. The two side walls 142 are spaced apart to form two grooves 143. The welding protrusions 33 of the two charging terminals 3 are each disposed in a corresponding groove 143. The collar 42 of each connector 4 is also disposed in a groove 143. The structure of the insulating body 1 provides space for the connection between the collar 42 and the welding protrusion 33.

As shown in FIG. 2, the charging structure also includes a support block 6. The support block 6 is disposed in the accommodating groove 11. A clamping slope 61 is disposed on a side of the support block 6 away from the bottom surface of the accommodating groove 11. The battery cell 2 abuts against the clamping slope 61. The battery cell 2 is driven by the clamping slope 61 to move toward the side walls 142 of the accommodating groove 11 so that the battery cell 2 is tightly clamped by the clamping slope 61 and the side walls 142 of the accommodating groove 11, ensuring the stability of the battery cell 2.

Further, the bottom of the battery cell 2 is provided with an adaptation slope. The adaptation slope is in sliding contact with the clamping slope 61.

As shown in FIG. 1 and FIG. 2, the charging structure also includes a flux 5. The flux 5 is sleeved on the welding protrusion 33 and is secured to the collar 42. The flux 5 is configured to weld and secure the welding protrusion 33 to the collar 42. After the flux 5 is melted by a welding gun, the flux 5 flows into the gap between the welding protrusion 33 and the collar 42. After the flux 5 is cooled and solidified, the welding of the welding protrusion 33 and the collar 42 is completed.

In one or more embodiments, the flux 5 is a soldering tin ball. The metallic properties of tin are suitable for welding. Before welding, the soldering tin ball is placed in the gap between the welding protrusion 33 and the collar 42.

As shown in FIG. 1 to FIG. 3, the connector 4 also includes an insulating sheath 43. The insulating sheath 43 covers the connecting section 41 and the collar 42 to improve the safety of the charging structure and avoid an internal short circuit of the wireless earphone.

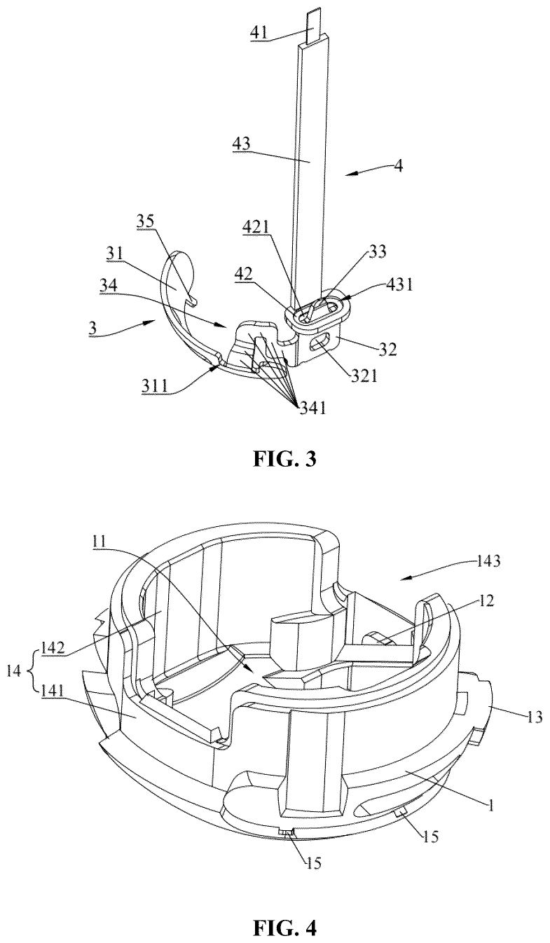

It is to be noted that when the flux 5 is heated and melted, the flux 5 flows to other positions, resulting in an insufficient amount of the flux 5 between the welding protrusion 33 and the collar 42 and affecting other structures. As shown in FIG. 3, to solve this problem, the insulating sheath 43 is provided with a limiting hole 431. The welding hole 421 is located in the limiting hole 431. The flux 5 is located in the limiting hole 431 and is secured to the collar 42.

That is, a limiting groove is formed between the limiting hole 431 and the collar 42, and the welding hole 421 of the collar 42 is completely located in the limiting groove. When the flux 5 is melted, due to the presence of the surface tension and a small distance between the welding hole 421 and the welding protrusion 33, the flux 5 does not pass through the gap between the welding hole 421 and the welding protrusion 33, so the flux 5 flows in the limiting groove, not only ensuring that the flux 5 does not flow to other positions, but also making the flux 5 uniformly fill the limiting groove; in this manner, the welding protrusion 33 is securely welded to the welding hole 421 in the circumferential direction, thereby improving the welding quality.

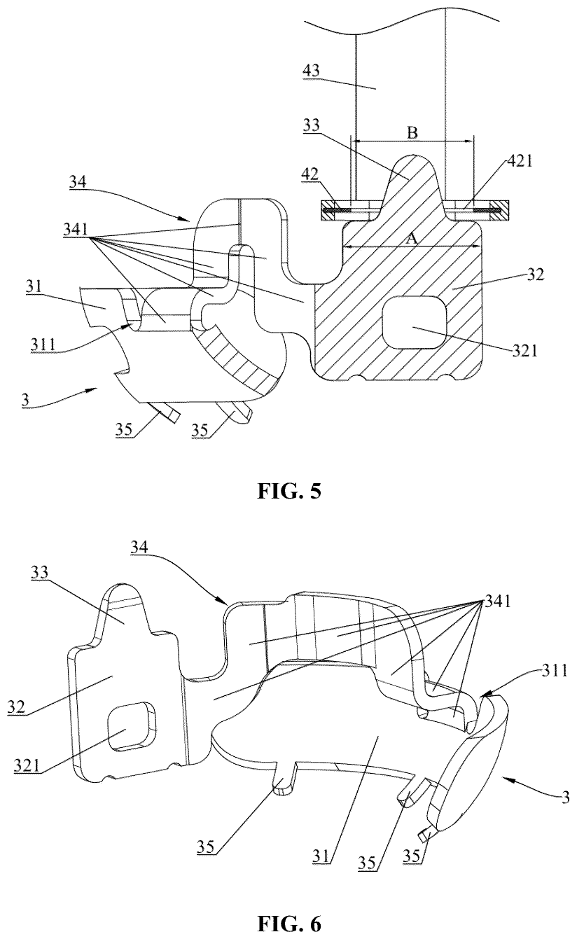

As shown in FIG. 5, in the direction in which the welding protrusion 33 is inserted into the welding hole 421, part of a projection of the welding portion 32 is located outside the welding hole 421. That is, the welding portion 32 cannot completely pass through the welding hole 421. Along the circumferential direction of the accommodating groove 11, the size A of the welding portion 32 is greater than the size B of the welding hole 421. After the flux 5 is melted, the welding portion 32 receives part of the melted flux 5, further reducing the possibility that the flux 5 passes through the gap between the welding hole 421 and the welding protrusion 33, ensuring that all of the flux 5 is cooled and solidified in the limiting groove, and thus improving the welding quality between the welding protrusion 33 and the collar 42.

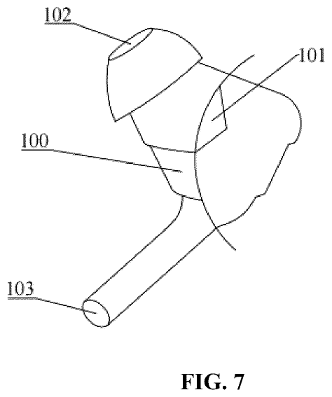

As shown in FIG. 3 to FIG. 6, the contact portion 31 is provided with multiple ridges 35. The ridges 35 are securely engaged with the insulating body 1 so that the contact area between the contact portion 31 and the insulating body 1 is increased and the connection strength between the contact portion 31 and the insulating body 1 in different directions is also improved, thereby ensuring that the contact portion 31 is not separated from the insulating body 1.

Correspondingly, the insulating body 1 is provided with engaging grooves 15 matching the ridges 35 one to one. Each ridge 35 is inserted into a corresponding engaging groove 15, improving the stability of the connection between the charging terminal 3 and the insulating body 1.

In this embodiment, the welding portion 32 is provided with a securing hole 321, and the insulating body 1 includes a securing protrusion 12. The securing protrusion 12 passes through the securing hole 321 to secure the welding portion 32. The securing protrusion 12 secures the welding portion 32, improving the stability of the welding portion 32, ensuring that the position of the welding portion 32 does not change during the process of sleeving the collar 42 of the connector 4 on the securing protrusion 12 and welding and thus improving the welding precision.

It is to be understood that in this embodiment, there is no additional securing structure between the charging terminal 3 and the insulating body 1. When the insulating body 1 is molded, the charging terminal 3 is placed in the molding die of the insulating body 1, is positioned, and then is injection molded. After the molding is completed, the charging terminal 3 and the insulating body 1 are fixed together to form an integrated structure. As shown in FIG. 3 to FIG. 6, to better improve the connection strength between the charging terminal 3 and the insulating body 1, the charging terminal 3 also includes a connecting portion 34. Two ends of the connecting portion 34 are connected to the contact portion 31 and the welding portion 32 respectively. The connecting portion 34 includes multiple connecting subsections 341 connected in sequence. Two adjacent connecting subsections 341 are disposed at an angle to each other.

Since the connecting portion 34 includes multiple connecting subsections 341 connected in sequence and two adjacent connecting subsections 341 are disposed at an angle to each other, the connecting portion 34 is a multi-segment bending structure. This structure is disposed inside the insulating body 1 so that the contact area between the connecting portion 34 and the insulating body 1 is increased and the insulating body 1 limits the connecting portion 34 in different directions, ensuring that the connecting portion 34 does not move relative to the insulating body 1 and thus improving the stability between the charging terminal 3 and the insulating body 1.

During the injection molding process, the connecting subsections 341 are embedded in the sidewall 14 of the insulating body 1, not only avoiding problems such as oxidation and short circuits caused by the exposure of the connecting subsections 341, but also improving the connection strength and ensuring that the connecting portion 34 does not move relative to the insulating body 1.

In this embodiment, the contact portion 31 is provided with an engaging groove 311, and the insulating body 1 is provided with an engaging portion 13. The engaging portion 13 is in an engaging fit with the engaging groove 311. The engaging portion 13 secures the contact portion 31 through the engaging groove 311, ensuring that the contact portion 31 does not move and thus ensuring that after the wireless earphone is placed in the charging compartment, the contact portion 31 is in contact with a contact point in the charging compartment to charge the battery cell 2.

Further, a connection position between the connecting portion 34 and the contact portion 31 is located in the engaging groove 311. It is to be understood that the portion of the insulating body 1 located at the engaging portion 13 has the largest thickness so that the connection position between the connecting portion 34 and the contact portion 31 is located in the engaging groove 311, improving the strength of the portion of the insulating body 1 in contact with the connecting portion 34.

To increase the distance between the two charging terminals 3 and improve the insulation, the two charging terminals 3 are symmetrically disposed along the central axis of the accommodating groove 11, the contact portions 31 of the two charging terminals 3 are disposed on opposite sides of the insulating body 1, and the welding portions 32 of the two charging terminals 3 are disposed on opposite sides of the insulating body 1.

As shown in FIG. 3, in the circumferential direction of the accommodating groove 11, the range of the contact portions 31 of the two charging terminals 3 does not overlap the range of the welding portions 32 of the two charging terminals 3.

The preceding are alternative embodiments of this disclosure. For those of ordinary skill in the art, according to the idea of this disclosure, there are changes in specific implementations and application scopes, and the content of this specification should not be construed as limiting this disclosure.

What is claimed is:

1. A charging structure, comprising:
an insulating body, wherein a top surface of the insulating body is provided with an accommodating groove, and one end of a battery cell is inserted into the accommodating groove;
two charging terminals disposed in the insulating body, wherein each of the two charging terminals comprises a contact portion and a welding portion, the contact portion is exposed outside the insulating body, and the welding portion is provided with a welding protrusion; and
two connectors, wherein each of the two connectors comprises a connecting section and a collar, and the collar is provided with a welding hole, wherein for each of the two connectors, the collar of the connector is sleeved on a corresponding welding protrusion through the welding hole of the connector and is securely welded to the corresponding welding protrusion, and connecting sections of the two connectors are connected to a positive electrode of the battery cell and a negative electrode of the battery cell, respectively.

2. The charging structure of claim 1, further comprising a flux, wherein the flux is sleeved on the welding protrusion and is secured to the collar.

3. The charging structure of claim 2, wherein each of the two connectors further comprises an insulating sheath, the insulating sheath covers the connecting section and the collar, the insulating sheath is provided with a limiting hole, the welding hole is located in the limiting hole, and the flux is located in the limiting hole and is secured to the collar.

4. The charging structure of claim 1, wherein in a direction in which the welding protrusion is inserted into the welding hole, part of a projection of the welding portion is located outside the welding hole.

5. The charging structure of claim 1, wherein the contact portion is provided with a plurality of ridges, and the plurality of ridges are embedded in the insulating body.

6. The charging structure of claim 1, wherein the welding portion is provided with a securing hole, the insulating body comprises a securing protrusion, and the securing protrusion passes through the securing hole to secure the welding portion.

7. The charging structure of claim 1, wherein each of the two charging terminals further comprises a connecting portion, two ends of the connecting portion are connected to the contact portion and the welding portion respectively, the connecting portion comprises a plurality of connecting subsections connected in sequence, and two adjacent ones of the connecting subsections are disposed at an angle to each other.

8. The charging structure of claim 7, wherein the contact portion is provided with an engaging groove, the insulating body is provided with an engaging portion, and the engaging portion is in an engaging fit with the engaging groove.

9. The charging structure of claim 8, wherein a connection position between the connecting portion and the contact portion is located in the engaging groove.

10. The charging structure of claim 2, wherein each of the two charging terminals further comprises a connecting portion, two ends of the connecting portion are connected to the contact portion and the welding portion respectively, the connecting portion comprises a plurality of connecting subsections connected in sequence, and two adjacent ones of the connecting subsections are disposed at an angle to each other.

11. The charging structure of claim 3, wherein each of the two charging terminals further comprises a connecting portion, two ends of the connecting portion are connected to the contact portion and the welding portion respectively, the connecting portion comprises a plurality of connecting subsections connected in sequence, and two adjacent ones of the connecting subsections are disposed at an angle to each other.

12. A wireless earphone, comprising a charging structure, a housing, a battery cell, and a speaker, wherein the housing is provided with a listening hole and a connecting hole, the charging structure closes the connecting hole, the speaker and the battery cell are disposed in the housing, the speaker is electrically connected to the battery cell, and the speaker is configured to play sound through the listening hole;
wherein the charging structure comprises an insulating body, two charging terminals disposed in the insulating body, and two connectors; wherein
a top surface of the insulating body is provided with an accommodating groove, and one end of the battery cell is inserted into the accommodating groove;
each of the two charging terminals comprises a contact portion and a welding portion, the contact portion is exposed outside the insulating body, and the welding portion is provided with a welding protrusion; and
each of the two connectors comprises a connecting section and a collar, and the collar is provided with a welding hole, wherein for each of the two connectors, the collar of the connector is sleeved on a corresponding welding protrusion through the welding hole of the connector and is securely welded to the corresponding welding protrusion, and connecting sections of the two connectors are connected to a positive electrode of the battery cell and a negative electrode of the battery cell, respectively.

13. The wireless earphone of claim 12, wherein the charging structure further comprises a flux, wherein the flux is sleeved on the welding protrusion and is secured to the collar.

14. The wireless earphone of claim 13, wherein each of the two connectors further comprises an insulating sheath, the insulating sheath covers the connecting section and the collar, the insulating sheath is provided with a limiting hole, the welding hole is located in the limiting hole, and the flux is located in the limiting hole and is secured to the collar.

15. The wireless earphone of claim 12, wherein in a direction in which the welding protrusion is inserted into the welding hole, part of a projection of the welding portion is located outside the welding hole.

16. The wireless earphone of claim 12, wherein the contact portion is provided with a plurality of ridges, and the plurality of ridges are embedded in the insulating body.

17. The wireless earphone of claim 12, wherein the welding portion is provided with a securing hole, the insulating body comprises a securing protrusion, and the securing protrusion passes through the securing hole to secure the welding portion.

18. The wireless earphone of claim 12, wherein each of the two charging terminals further comprises a connecting portion, two ends of the connecting portion are connected to the contact portion and the welding portion respectively, the connecting portion comprises a plurality of connecting subsections connected in sequence, and two adjacent ones of the connecting subsections are disposed at an angle to each other.

19. The wireless earphone of claim 18, wherein the contact portion is provided with an engaging groove, the insulating body is provided with an engaging portion, and the engaging portion is in an engaging fit with the engaging groove.

20. The wireless earphone of claim 19, wherein a connection position between the connecting portion and the contact portion is located in the engaging groove.
